(19) United States
(12) Patent Application Publication
(10) Pub. No.: US 2024/0144830 A1
(43) Pub. Date: May 2, 2024

(54) SERVER APPARATUS AND METHOD OF CONTROLLING THE SAME

(71) Applicants: HYUNDAI MOTOR COMPANY, Seoul (KR); KIA CORPORATION, Seoul (KR)

(72) Inventor: Hyunmok Kim, Seoul (KR)

(73) Assignees: HYUNDAI MOTOR COMPANY, Seoul (KR); KIA CORPORATION, Seoul (KR)

(21) Appl. No.: 18/232,613

(22) Filed: Aug. 10, 2023

(30) Foreign Application Priority Data
Nov. 1, 2022 (KR) 10-2022-0143848

(51) Int. Cl. G08G 1/00; G08G 1/0967; H04W 4/024

(52) U.S. Cl. CPC G08G 1/202; G08G 1/096775; H04W 4/024

(57) ABSTRACT

A server apparatus and a method of controlling the same are disclosed. The server apparatus includes a communicator configured to communicate with a plurality of vehicles belonging to a predetermined group and includes a controller. The controller is configured to control, upon receiving an accident occurrence signal from an accident vehicle included in the plurality of vehicles, the communicator to transmit an assistance request signal to a target vehicle to be notified selected based on a location of the accident vehicle of the plurality of vehicles.

### CROSS-REFERENCE TO RELATED APPLICATION

This application claims the benefit of and priority to Korean Patent Application No. 10-2022-0143848, filed on Nov. 1, 2022, the entire contents of which are incorporated herein by reference.

### TECHNICAL FIELD

The present disclosure relates to a server apparatus for coping with situations that may occur while driving in a group and relates to a method of controlling a server apparatus.

### BACKGROUND

Generally, in transportation, group driving (also referred to as platooning) refers to several vehicles that belong to a certain group to drive to the same destination.

When a plurality of vehicles moves as a group, location information between the plurality of vehicles may be shared through a server and driving routes thereof may be tracked and displayed.

At this time, when an accident occurs in one vehicle among the plurality of vehicles in a group, a technology for quickly assisting the accident is required.

### SUMMARY

An aspect of the present disclosure provides a server apparatus configured to change a route to an accident vehicle by notifying adjacent vehicles in a group about the accident when the accident involves a vehicle in the group. The present disclosure also provides a method of controlling such a server apparatus.

Additional aspects of the disclosure are set forth, in part, in the description which follows and should be, in part, understood from the description or may be, in part, learned by practice of the disclosure.

In accordance with an embodiment of the present disclosure, a server apparatus includes a communicator configured to communicate with a plurality of vehicles belonging to a predetermined group. The server apparatus also includes a controller configured to control, upon receiving an accident occurrence signal from an accident vehicle included in the plurality of vehicles, the communicator to transmit an assistance request signal to a target vehicle to be notified selected based on a location of the accident vehicle of the plurality of vehicles.

The controller may select a vehicle having the closest distance from the accident vehicle among the plurality of vehicles as the target vehicle to be notified.

The controller may control the communicator to receive a response signal regarding a request for assistance from the target vehicle to be notified.

The controller may control the communicator to transmit location information of the accident vehicle to the target vehicle to be notified as a destination based on receiving of an acceptance signal as the response signal for the assistance request from the target vehicle to be notified.

The controller may change, based on receiving of a rejection signal as the response signal for the assistance request from the target vehicle to be notified, a vehicle next closest to the accident vehicle following the target vehicle to be notified received the rejection signal as the target vehicle to be notified.

The controller may control, based on receiving of an acceptance signal as the response signal for the assistance request from the target vehicle to be notified, the communicator to transmit joining information of the target vehicle to be notified to the accident vehicle.

The joining information may include at least one of information on a driver of the target vehicle to be notified, a current location, and an expected arrival time to the location of the accident vehicle.

The accident occurrence signal may include a collision detection signal or an airbag deployment signal of the accident vehicle.

The controller may control, based on inputting of an instruction regarding the assistance request through an input device by a driver of the accident vehicle, the communicator to transmit the assistance request signal to the target vehicle to be notified.

In accordance with another embodiment of the present disclosure, a method of controlling a server apparatus is provided. The method includes receiving an accident occurrence signal from an accident vehicle included in a plurality of vehicles. The method also includes transmitting, upon receiving the accident occurrence signal, an assistance request signal to a vehicle to be notified selected based on a location of the accident vehicle of the plurality of vehicles.

The selection of the target vehicle to be notified may be to select a vehicle having the closest distance from the accident vehicle among the plurality of vehicles as the target vehicle to be notified.

The method may further include receiving a response signal regarding a request for assistance from the target vehicle to be notified.

The method may further include transmitting location information of the accident vehicle to the target vehicle to be notified as a destination based on receiving of an acceptance signal as the response signal for the assistance request from the target vehicle to be notified.

The method may further include changing, based on receiving of a rejection signal as the response signal for the assistance request from the target vehicle to be notified, a vehicle next closest to the accident vehicle following the target vehicle to be notified received the rejection signal as the target vehicle to be notified.

The method may further include transmitting, based on receiving of an acceptance signal as the response signal for the assistance request from the target vehicle to be notified, joining information of the target vehicle to be notified to the accident vehicle.

The joining information may include at least one of information on a driver of the target vehicle to be notified, a current location, and an expected arrival time to the location of the accident vehicle.

The accident occurrence signal may include a collision detection signal or an airbag deployment signal of the accident vehicle.

The transmitting of the assistance request signal may further include transmitting the assistance request signal to the target vehicle to be notified based on inputting of an instruction regarding the assistance request through an input device by a driver of the accident vehicle.

### BRIEF DESCRIPTION OF THE DRAWINGS

These and/or other aspects of embodiments of the disclosure should be apparent and more readily appreciated from the following description of the embodiments, taken in conjunction with the accompanying drawings, in which:

FIG. 1 is a block diagram illustrating a server apparatus according to an embodiment of the present disclosure;

FIG. 2 is a view illustrating an example of communication between a server apparatus and a plurality of vehicles according to an embodiment of the present disclosure;

FIG. 3 is a view illustrating that an accident occurs in one vehicle of a group of vehicles according to an embodiment of the present disclosure;

FIG. 4 is a view illustrating that a server apparatus according to an embodiment of the present disclosure determines a target vehicle to be notified by determining a distance to an accident vehicle;

FIG. 5 is a view illustrating that a server apparatus according to an embodiment of the present disclosure communicates with an accident vehicle and a target vehicle to be notified;

FIG. 6 is a view illustrating that a target vehicle to be notified receives a request for assistance in a vehicle according to an embodiment of the present disclosure;

FIG. 7 is a view illustrating that a route of the target vehicle to be notified is changed when a server apparatus according to an embodiment of the present disclosure receives an acceptance signal for a request for assistance;

FIG. 8 is a flowchart illustrating a control flow of an accident vehicle in which an accident occurs in a server apparatus according to an embodiment of the present disclosure;

FIG. 9 is a flowchart illustrating a control flow of the other vehicles in the group except for an accident vehicle in a server apparatus according to an embodiment of the present disclosure;

FIG. 10 is a further flowchart illustrating a control flow of the other vehicles in the group except for an accident vehicle in the server apparatus according to an embodiment of the present disclosure;

FIG. 11 is a main flowchart illustrating a control flow in a server apparatus according to an embodiment of the present disclosure; and

FIG. 12 is a further main flowchart illustrating a control flow in a server apparatus according to an embodiment of the present disclosure.

The drawings described herein are for illustration purposes only and are not intended to limit the scope of the present disclosure in any way.

### DETAILED DESCRIPTION

The following description is provided by way of example and is not intended to limit the present disclosure, application, or uses. It should be understood that, throughout the drawings, corresponding reference numerals indicate like or corresponding parts and features.

Reference is made below in detail to the embodiments of the disclosure, examples of which are illustrated in the accompanying drawings. This present disclosure does not describe all elements of the disclosed embodiments and detailed descriptions of what is well known in the art, and redundant descriptions of substantially the same configurations have been omitted. The terms ‘part’, ‘module’, ‘member’, ‘block’ and the like as used in the present disclosure may be implemented in software or hardware. Further, a plurality of ‘parts’, ‘modules’, ‘members’, ‘blocks’ and the like may be embodied as one component. It is also possible that one ‘part’, ‘module’, ‘member’, ‘block’ and the like includes a plurality of components.

Throughout the present disclosure, when an element is referred to as being “connected to” another element, the element may be directly or indirectly connected to the other element. When an element is referred to as being “indirectly connected to” another element, the element may be connected to the other element via a wireless communication network.

Also, it should be understood that the terms “include” and “have” are intended to indicate the existence of elements disclosed in the present disclosure. These terms are not intended to preclude the possibility that one or more other elements may exist or may be added.

Throughout the present disclosure, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural, unless the expression has a clearly different meaning in the context.

The reference numerals used in operations are used for descriptive convenience and are not intended to describe the order of operations. The operations may be performed in a different order unless otherwise stated.

When a component, device, element, or the like of the present disclosure is described as having a purpose or performing an operation, function, or the like, the component, device, or element should be considered herein as being “configured to” meet that purpose or to perform that operation or function.

Hereinafter, embodiments of the disclosure are described in detail with reference to the accompanying drawings.

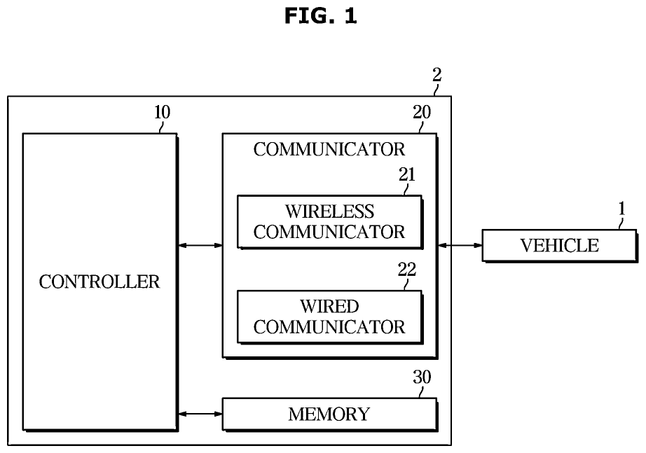

FIG. 1 is a control diagram illustrating a server apparatus according to an embodiment.

Referring to FIG. 1, a server apparatus 2 may include a communicator 20, a memory 30, and a controller 10.

The communicator 20 may communicate with a vehicle 1 that constitutes a group through a wireless communication base station, and various communication methods may be applied.

For example, the communicator 20 may adopt a 2nd generation (2G) communication method, such as time division multiple access (TDMA) and code division multiple access (CDMA). The communicator 20 may adopt a 3rd generation (3G) communication methods, such as wide code division multiple Access (WCDMA), code division multiple access 2000 (CDMA2000), wireless broadband (Wibro), and world interoperability for microwave access (WiMAX). The communicator 20 may adopt a 4th generation (4G) communication method, such as long term evolution (LTE) and wireless broadband evolution (WBE). The communicator 20 may adapt a 5th generation (5G) communication method.

The communicator 20 may include one or more components enabling communication with an external device and may include, for example, at least one of a short-range communication module, a wired communicator 22, or a wireless communicator 21.

The short-range communication module may include various short-range communication modules that transmit and receive signals using a wireless communication network, such as a Bluetooth module, an infrared communication module, a radio frequency identification (RFID) communication module, a wireless local access network (WLAN) communication module, a near field communication (NFC) communication module, a Zigbee communication module, and the like.

The wired communicator 22 may include a various wired communicators 22, such as a controller area network (CAN) communication module, a local area network (LAN) module, a wide area network (WAN) module, or a value added network (VAN) module, and also include a various cable communication modules, such as a universal serial bus (USB), high definition multimedia interface (HDMI), digital visual interface (DVI), recommended standard 232 (RS-232), power line communication, plain old telephone service (POTS), and the like.

The wireless communicator 21 may include a wireless communicator 21 supporting various wireless communication methods, such as a radio data system-traffic message channel (RDS-TMC), digital multimedia broadcasting (DMB), a wireless fidelity (WiFi) module, a wireless broadband module, and the like, as well as global system for mobile communication (GSM), code division multiple access (CDMA), wideband code division multiple access (WCDMA), universal mobile telecommunications system (UMTS), time division multiple access (TDMA), long term evolution (LTE), and the like.

The wireless communicator 21 may include a wireless communication interface including an antenna for receiving a response to an assistance request signal from the vehicle 1 and a receiver. In addition, the wireless communicator 21 may further include a signal conversion module for demodulating an analog type of wireless signal received through a wireless communication interface into a digital control signal.

The communicator 20 may receive, when road information, such as closed-circuit television (CCTV) information of a road, speed cameras, sensor data of an autonomous vehicles, and data of surrounding vehicles, is collected, the collected road information from an external device (not shown).

The communicator 20 may transmit an assistance request signal to a target vehicle to be notified and may transmit joining information of the target vehicle to be notified 1 to an accident vehicle 1-4.

The memory 30 may include a volatile memory 30, such as a static random access memory (S-RAM), a dynamic random access memory (D-RAM), and a non-volatile memory 30, such as a read only memory (ROM) and an erasable programmable read only memory (EPROM). The memory 30 may include one memory 30 element or may include a plurality of memory 30 elements.

The memory 30 may store common destination information of a group driving and may store a driver information and location information of a group of vehicles.

Upon receiving an accident occurrence signal from the accident vehicle 1-4 included in a plurality of vehicles 1 during the group driving, the controller 10 may control the communicator 20 to transmit an assistance request signal to the target vehicle to be notified 1 selected from among the plurality of vehicles 1.

Herein, the group driving may refer to that the plurality of vehicles 1 belong to one group to travel to the same destination.

More specifically, the server apparatus 2 according to an embodiment may set the plurality of vehicles 1 to drive to the same destination as one driving group.

To this end, the server apparatus 2 may receive a request for group creation from a leader vehicle 1-1, which is one vehicle among the plurality of vehicles 1.

The controller 10 may receive, through the communicator 20, a request for inviting and deleting group member vehicles 1-n corresponding to group members from the leader vehicle 1-1.

At this time, the leader vehicle 1-1 is a vehicle, which creates the corresponding group, and the leader vehicle has the authority to set destinations for the corresponding group.

The server apparatus 2 may receive current location information and collected road traffic conditions of all vehicles including the leader vehicle 1-1 and group member vehicles 1-n through the communicator 20.

More specifically, the controller 10 may receive GPS information to calculate the locations of all vehicles 1 belonging to the group, routes to destinations, and driving routes.

To calculate a driving route, the controller 10 may utilize a navigation system, which is a road and traffic information providing system, for guiding an optimal route in consideration of a distance from a current location to a destination and traffic conditions.

Such a navigation system may include a receiver (GPS antenna) for calculating the current position by receiving radio waves from global navigation satellite system (GNSS) within the server apparatus 2, electronic maps for providing road and route information, and software and storage devices that calculate and guide the optimal route considering road and traffic conditions.

Then, the controller 10 may control the communicator 20 to transmit information, such as the location and driving route of each of the leader vehicle 1-1 and group member vehicles 1-n to all vehicles 1.

Accordingly, all vehicles belonging to one group may share respective location information of vehicles.

Furthermore, a method in which each vehicle shares location information may be a vehicle to vehicle (V2V) communication.

The V2V communication refers to a communication between vehicles and may transmit and receive data through wireless communication unique to each vehicle 1. The V2V communication may utilize all types of wireless components so that vehicles may communicate with each other and form Vehicle Ad Hoc Network (VANET).

As such, a method for each vehicle 1 to share location information is not limited thereto.

The vehicle 1 may include a user interface (not shown), and the user interface may refer to a device for a driver belonging to a group to directly input an assistance request signal or for displaying joining information of other group members.

The user interface may include a display for displaying joining information of other group members and an input device 41 for receiving an assistance request signal from the driver.

The user interface may include an audio/video/navigation (AVN) display. However, in an embodiment, the input device 41 that receives an instruction of a user and an output device 42 that displays the joining information of other group members are not necessarily limited to the AVN display.

The user interface may be the input device 41 as long as the driver on the vehicle 1 may input an instruction even if it is not the AVN display and may be the output device 42 if a displayed content may be confirmed.

For example, the input device 41 may be an automotive voice recognition system, and the output device 42 may be a speaker inside the vehicle 1 outputting sound.

When a user utters an instruction by voice, the automotive voice recognition system may analyze the input instruction, determine a domain corresponding to the instruction, and perform an operation thereof.

Accordingly, when the input device 41 becomes the automotive voice recognition system, the user may input the instruction for requesting assistance by voice or confirm the joining information of other vehicles of the group by voice.

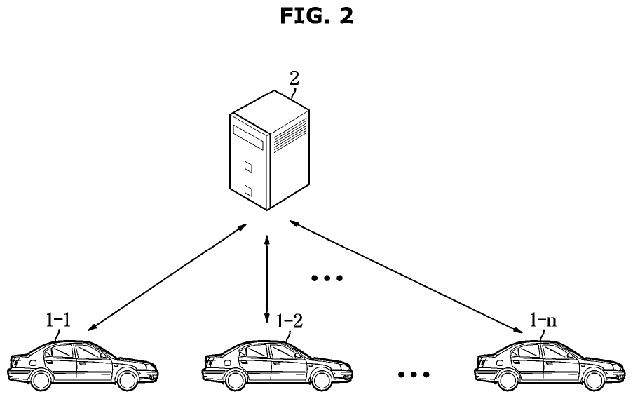

FIG. 2 is a view illustrating an example of communication between a server apparatus according to an embodiment and a plurality of vehicles.

Referring to FIG. 2, the server apparatus 2 according to an embodiment may determine the plurality of vehicles 1-1, 1-2, . . . , 1-n as one group. Then, the server apparatus 2 may identify the accident vehicle 1-4 among the plurality of vehicles 1-1, 1-2, . . . , 1-n based on the accident occurrence signal and may select the target vehicle to be notified among the remaining vehicles excluding the accident vehicle 1-4.

To this end, the server apparatus 2 may perform wireless communication with the plurality of vehicles 1-1, 1-2, . . . , 1-n via a network. In this case, well-known communication techniques may be used for wireless communication.

The vehicle 1 according to an embodiment may include a vehicle using an internal combustion engine, a vehicle powered by electricity, an electric unicycle, an electric kickboard, an electric bicycle, a micro electric vehicle, and the like. The type of vehicle 1 is not limited to the above examples, and any vehicle capable of communicating with the server apparatus 2 may be included without limitation.

The server apparatus 2 according to an embodiment may perform wireless communication with the plurality of vehicles 1-1, 1-2, . . . , 1-n via a network and may perform wireless communication with the plurality of vehicles 1-1. The accident vehicle 1-4 among the plurality of vehicles 1-1, 1-2, . . . , 1-n may transmit the accident occurrence signal to the server apparatus, and the target vehicle to be notified may receive the assistance request signal.

The network (not shown) according to an embodiment may support communication between the server apparatus 2 and the plurality of vehicles 1-1, 1-2, . . . , 1-n and may be at least one of a telecommunications network, for example, a computer network (e.g., a LAN or WAN), an Internet, or a telephone network. However, as described above, a type of network is not limited to the above examples, and any network for supporting communication may be included without limitation.

As shown in FIG. 2, among the plurality of vehicles 1-1, 1-2, . . . , 1-n, the server apparatus 2 may determine the number of vehicles that include in one group from 2 to n, and the server apparatus 2 may set a leader vehicle 1-1.

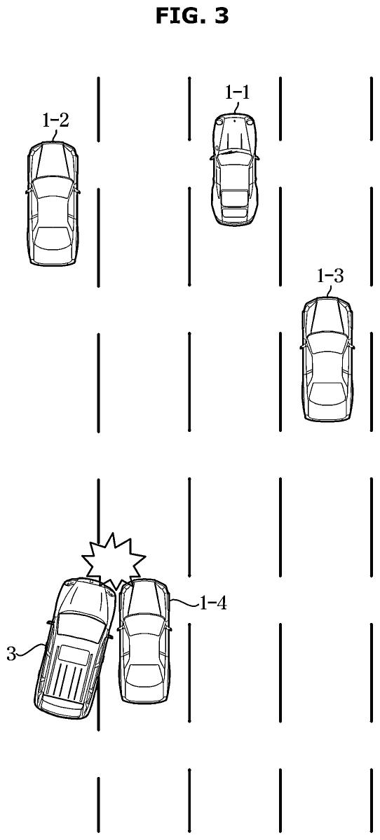

FIG. 3 is a view illustrating that an accident occurs in one vehicle among a group of vehicles in a server apparatus according to an embodiment.

Referring to FIG. 3, a collision accident may be occurred in some of the plurality of vehicles 1-1, 1-2, . . . , 1-n. Traffic accidents are rapidly increasing every year, and accidents that occur in places where there are few people or where the traffic volume of vehicles is small may be difficult to handle quickly.

Furthermore, the driver may suffer serious physical damage due to an accident that occurs in the vehicle 1, and accordingly, if the accident situation may not be promptly reported to a hospital or police station, the occupant may be endangered.

As shown in FIG. 3, if the vehicle 1-4 (or accident vehicle) in which the accident has occurred is the rearmost vehicle 1 of the group of vehicles, despite driving at a short distance, it may be difficult to report the accident because the vehicle 1-4 does not enter the field of view of other vehicles of the group of vehicles, which are preceding from the front.

In addition, generally, the group driving is performed between vehicles at a distance where the other group members are invisible to the field of view of the vehicle of the group members. In other words, the group driving refers to a technology in which a plurality of vehicles from different departure form a group in which they drive to the same destination and various information may be shared between group member vehicles. Accordingly, in most cases, the other vehicles 1 of the group of vehicles does not recognize the accident content of the accident vehicle 1-4.

As a result, it may be more difficult for other vehicles in the group of vehicles 1 to report the accident of the accident vehicles 1-4 positioned at a distance.

The server apparatus 2 according to an embodiment may receive the accident occurrence signal directly from the accident vehicle 1-4 in which the accident occurred among the group of vehicles 1 and thus may solve delay in reporting the accident as described above.

More specifically, the server apparatus 2 may receive the accident occurrence signal directly from the accident vehicle 1-4 in which the accident occurs among the group of vehicles 1 and may change a route of the vehicle 1 that has accepted the assistance request signal among the adjacent vehicles 1-1, 1-2, and 1-3 in the group.

At this time, the accident occurrence signal may include a collision detection signal or an airbag deployment signal of the accident vehicle 1-4 and may include any message configured for detecting an occurrence of an accident.

The accident occurrence signal received by the server apparatus 2 is not limited to the collision detection signal, the airbag deployment signal, and the message configured for detecting the accident occurrence. As long as the server apparatus 2 detects the accident occurrence in the vehicle 1, the accident occurrence signal is not limited thereto.

The server apparatus 2 may change the route of the vehicle 1 in response to the assistance request signal among the target vehicles to be notified, which are the adjacent vehicles in the group 1, from the common destination to an accident location of the accident vehicles 1-4. The server apparatus 2 may transmit the changed route to the target vehicle to be notified in response to the assistance request signal.

As a result, the target vehicle to be notified driving nearby may quickly join the accident vehicle 1-4 and may reach the accident vehicle 1-4 in a shorter time than the emergency rescue team or the police.

In other words, since the other vehicles 1 belonging to the group are traveling to the common destination even if the other vehicles 1 depart from at relatively distant departures, the distance between each two vehicles 1 in the group may decrease over time. Accordingly, the accident vehicles 1-4 may be helped by the group member positioned nearby faster than helped by emergency rescue team.

In the server apparatus 2 according to an embodiment, when an accident occurs in a place where people are rare or where the traffic volume of the vehicle 1 is low, getting help from nearby group members may be more effective than help by emergency rescue team.

In the following drawings from FIG. 3, a case in which the accident vehicle 1-4 cannot move to the common destination due to an accident occurred in the accident vehicle 1-4 is described as an example. However, in the present disclosure, the accident vehicle 1-4 may include vehicles in all cases in which a vehicle is unable to drive to a group destination due to a breakdown of the vehicle while driving in group driving or a schedule change of a passenger.

Accordingly, according to the present invention, when a group member vehicle (“the accident vehicle”), due to a change in circumstances during group driving, is unable to travel to the group destination, the group member vehicle transmits an assistance request signal to another group member vehicle. When another group member vehicle arrives, the occupant riding the accident vehicle may ride another group member vehicles together to reach the group destination.

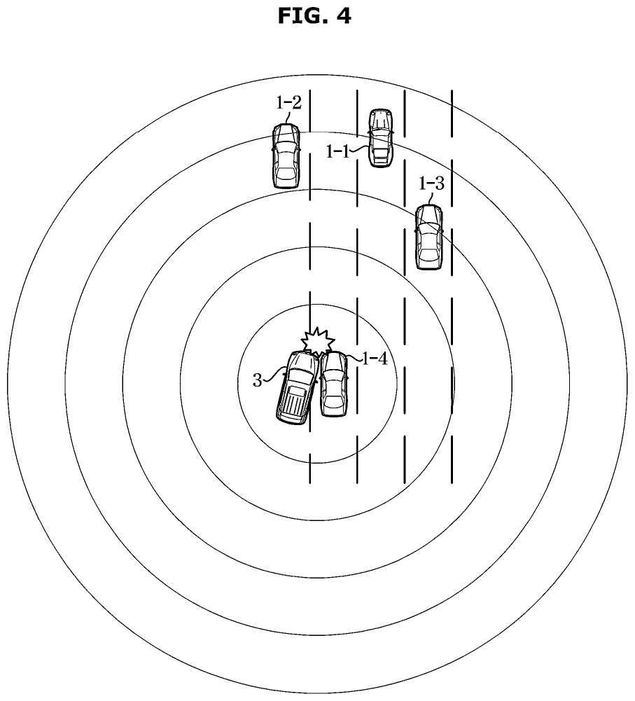

FIG. 4 is a view illustrating that a server apparatus according to an embodiment determines a target vehicle to be notified by determining a distance with the accident vehicle.

Referring to FIG. 4, the server apparatus 2 may determine a distance with the accident vehicle 1-4 using a plurality of circles having the accident vehicle 1-4 as a center point.

As described above, the server apparatus 2 may receive the current location information of all vehicles 1 including the leader vehicle 1-1 and group member vehicles 1-n and may receive the collected road traffic conditions through the communicator 20.

Accordingly, the server apparatus 2 may grasp the current locations of all vehicles 1 constituting one group in real time.

As a result, the server apparatus 2 may calculate a distance between the accident vehicle 1-4 and a group member 1 (also referred to as 1-1), a group member 2 (also referred to as 1-2), and group member 3 (also referred to as 1-3) included in the same group as the accident vehicle 1-4.

As shown in FIG. 4, the server apparatus 2 may determine that the group member 3 (i.e., 1-3) is the vehicle 1 having the closest distance from the accident vehicle 1-4, may determine that the group member 2 (i.e., 1-2) is the vehicle 1 having the second closest distance from the accident vehicle 1-4, and may determine that the group member 1 (i.e., 1-1) is the vehicle 1 having the farthest distance from the accident vehicle 1-4.

At this time, the group member 1 (i.e., 1-1) may be the leader vehicle of the group which creates one group.

The controller 10 may store the order of proximity to the accident vehicle 1-4 in which the accident occurs and may store the locations of the group member vehicles 1-n in the memory 30.

In addition, as described below, the controller 10 may transmit the assistance request signal for changing a route to the accident vehicle 1-4 in order of the vehicle 1 having a short distance from the accident vehicle 1-4.

In FIG. 4, for convenience of understanding, it is shown that the assistance request signal is transmitted based on the distance determined on the concentric circle, but the controller may determine the distance between the accident vehicle 1-4 and the group member vehicles 1-n based on GPS information and may transmit the assistance request signal to the group member vehicle 1-n close to the accident vehicle 1-4.

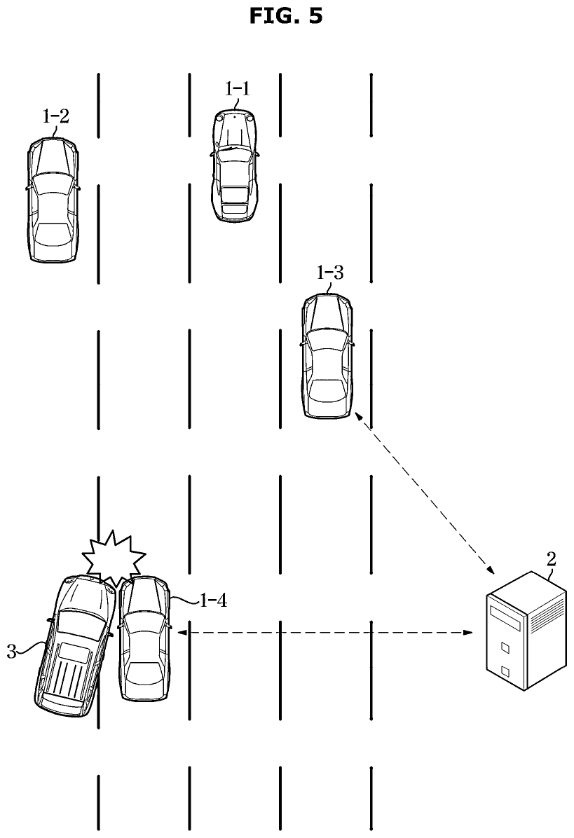

FIG. 5 is a view illustrating that a server apparatus according to an embodiment communicates with an accident vehicle and a target vehicle to be notified.

Referring to FIG. 5, the controller 10 may select a vehicle having the shortest distance from the accident vehicle 1-4 of the plurality of vehicles 1 as the target vehicle to be notified 1-3.

Herein, the selection of the target vehicle to be notified 1-3 by the controller 10 is for transmitting the assistance request signal to the target vehicle to be notified 1-3, and the controller 10 may control the communicator 20 in order to receive a response signal regarding the request for assistance from the target vehicle to be notified 1-3.

The controller 10 may select any one of the group member vehicles 1-n as the target vehicle to be notified 1-3 and may transmit a message to confirm whether the request for assistance is accepted. In detail, the controller 10 may confirm whether the selected target vehicle to be notified 1-3 agrees to change the destination to a location of the accident vehicle 1-4.

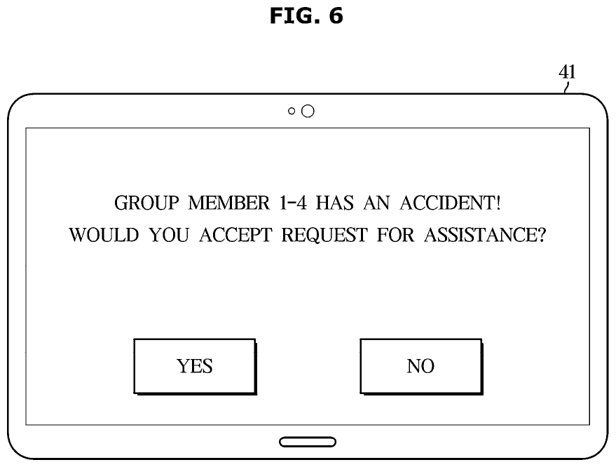

The driver of the target vehicle to be notified 1-3 may accept or reject the request for assistance through the input device 41 as shown in FIG. 6. The controller 10 may receive the response signal regarding the request for assistance from the notification target vehicle 1-3.

In other words, when a situation where the occupants of the accident vehicle 1-4 cannot move to the group destination arises, the accident vehicle 1-4 may transmit the assistance request signal for a ride to the target vehicle to be notified 1-3. In addition, the driver of the target vehicle to be notified 1-3 may transmit a rejection signal regarding the request for assistance due to a lack of remaining seats in the vehicle, an abnormal vehicle condition, and the like.

The controller 10 may change the vehicle 1-2 having the next closest distance from the accident vehicle 1-4 as the target vehicle to be notified 1-2 based on the receiving of the rejection signal from the target vehicle to be notified 1-3 as the response signal for the request for assistance.

More specifically, the driver of the vehicle selected as the target vehicle to be notified 1-3 may reject the request for assistance for reasons such as illness, disability, personal business, or the like, in addition to the above-described reasons. The controller 10 may re-select the vehicle having the next closest distance from the accident vehicle 1-4 following the selected target vehicle to be notified 1-3, as the target vehicle to be notified 1-2.

As a result, in the server apparatus 2 according to an embodiment, it is possible to help the accident vehicles 1-4 in consideration of the intentions of the group members and thus take action more efficiently against accident.

Referring to FIG. 5 continuously, when the acceptance signal is received from group member 3 (i.e., 1-3) as the response signal for the assistance request, the controller 10 may transmit location information of the accident vehicle 1-4 to the group member 3 (i.e., 1-3) as the destination.

At this time, the controller 10 may transmit the location information of the accident vehicle 1-4 as the destination to the group member 3 (i.e., 1-3) or may calculate an optimal route to the location of the accident vehicle 1-4 to transmit the calculated route to the group member 3 (i.e., 1-3).

When the rejection signal is received from the group member 3 (i.e., 1-3) as the response signal for the request for assistance, the controller 10 may change the group member 2 (i.e., 1-2) having the next closest distance from the accident vehicle 1-4 following the group member 3 (i.e., 1-3) as the target vehicle to be notified 1.

Then, when the rejection signal is received from group member 2 (i.e., 1-2) as the response signal for the request for assistance, the controller 10 may change the group member 1 (i.e., 1-1) having the next closest distance from the accident vehicle 1-4 following the group member 2 (i.e., 1-2) as the target vehicle to be notified 1.

When the acceptance signal is received from one vehicle 1 of group members as the response signal regarding the request for assistance, the controller 10 may control the communicator 20 to transmit the joining information of the target vehicle to be notified 1 to the accident vehicle 1-4.

At this time, the joining information of the target vehicle to be notified 1-3 may include at least one of driver information of the target vehicle to be notified 1, a current location, or the expected arrival time to the location of the accident vehicle 1-4.

In other words, when transmitting the assistance request signal to the target vehicle to be notified 1-3 and receiving the acceptance signal from the target vehicle to be notified 1-3, the controller 10 may notify the accident vehicle 1-4 of the approach of the target vehicle to be notified 1-3.

Accordingly, the server apparatus 2 according to an embodiment may inform the driver that a group member is coming even when the driver of the accident vehicle 1-4 is seriously injured and unable to use his/her body, so that psychological stability may be provided to the driver of the accident vehicle 1-4.

Not only when an accident occurs, but also when the driver inputs an instruction associated with the requesting for assistance through the input device 41 provided in the vehicle 1, the controller 10 may control the communicator 20 to transmit the assistance request signal to the target vehicle to be notified 1-3.

For example, upon determining that the vehicle 1 runs out of fuel or the driver needs help based on his/her own discretion, the controller 10 may input an instruction associated with the request for assistance through the input device 41.

At this time, the instruction regarding the request for assistance may be implemented with a simple interface, and the request for assistance may be faster than a phone call or message on a smartphone by utilizing the AVN network or voice recognition.

FIG. 6 is a view illustrating that a target vehicle to be notified receives a request for assistance in a vehicle according to an embodiment.

As described above, the input device 41 of the vehicle 1 may be provided as the AVN display, but is not limited thereto, and may include a voice recognition system for a vehicle.

Referring to FIG. 6, the input device 41 of the vehicle 1 is composed of the AVN display, and the driver may transmit the acceptance or rejection signal to the server apparatus 2 for the assistance request signal by selecting ‘yes’ or ‘no’ to the assistance request signal.

For another example, when the input device 41 of the vehicle 1 is the voice recognition system for a vehicle, the driver may utter a command for voice recognition to determine whether to accept the request for assistance.

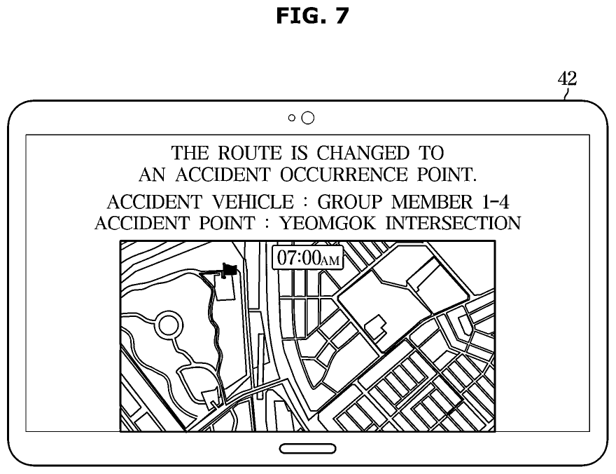

FIG. 7 is a view illustrating that a route of a target vehicle to be notified is changed when a server apparatus according to an embodiment receives an acceptance signal for a request for assistance.

Referring to FIG. 7, the output device 42 is provided as the AVN display to inform the driver of the changed route.

In detail, the controller 10 may transmit a simple message such as “The route is changed to an accident occurrence point” to the output device 42 of the target vehicle to be notified 1.

Furthermore, the controller 10 may transmit group member 4 (i.e., 1-4), which is information about the accident vehicle 1-4, and “Yeomgok intersection”, which is a specific accident point, in the form of a message.

At this time, the controller 10 may transmit the destination of the target vehicle to be notified 1-3 or may calculate an optimal route to the destination and transmit the calculated route and destination together.

The controller 10 may calculate an optimal route to the destination and transmit the calculated route not only to the target vehicle to be notified 1-3 but also to the accident vehicle 1-4.

In other words, the controller 10 may inform the accident vehicle 1-4 of the approach route of the target vehicle to be notified 1-3 and thus may provide psychological stability to the driver in an accident situation.

Thereafter, the target vehicle to be notified 1-3 that has transmitted the acceptance signal for the request for assistance from the server apparatus 2 may change an existing route according to the received destination or route and join the accident vehicle 1-4.

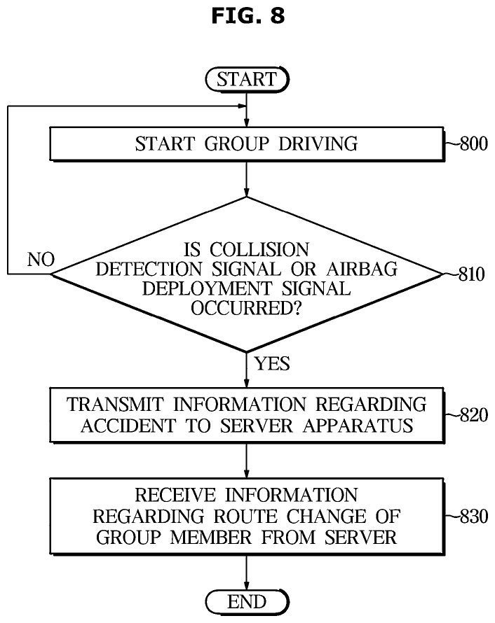

FIG. 8 is a flowchart illustrating a control flow of an accident vehicle in which an accident occurs in a server apparatus according to an embodiment.

Referring to FIG. 8 from the viewpoint of the accident vehicles 1-4, the plurality of vehicles 1 belonging to one group may start the group driving (800).

At this time, the group driving may be generated from the leader vehicle 1-1 and may include a plurality of group member vehicles 1-n. The group driving may have a common destination, and the first destination may be set by the leader vehicle 1-1.

The controller 10 of the server apparatus 2 may determine whether an accident has occurred in one vehicle 1 among the plurality of vehicles 1 belonging to the group during the group driving (810). At this time, the vehicle 1 in which the accident has occurred may include both the leader vehicle 1-1 and the group member vehicles 1-n.

As described above, in the present disclosure, the accident vehicles 1-4 may include, in addition to a case where a traffic accident occurs and the vehicle cannot move to the group destination, all cases in which the vehicle cannot drive to the group destination due to a breakdown while driving in the group driving or a change in the schedule of a passenger.

Accordingly, in the present disclosure, when a group member vehicle, due to a situation change, is unable to drive to the group destination during the group driving, the group member vehicle may transmit the assistance request signal to the other group member vehicles. When the any other group member vehicles arrive, the occupants who have ridden in the group member vehicle may ride in the other group member vehicles together to move to the group destination.

When the controller 10 of the server apparatus 2 determines that an accident has occurred in one vehicle 1 (Yes in 820), the accident vehicle 1-4 may transmit information regarding the accident to the server apparatus 2 (820). The server apparatus 2, when an accident occurs in one vehicle 1 belonging to the group, may define the corresponding vehicle 1 as the accident vehicle 1-4.

In other words, the server apparatus 2 may determine whether an accident has occurred based on the fact that the server apparatus 2 receives a collision detection signal or an airbag deployment signal of the vehicle 1.

Thereafter, the server apparatus 2 may select the target vehicle to be notified 1, may confirm whether the target vehicle to be notified 1 accepts the request for assistance, and may transmit information regarding the route change of the target vehicle to be notified 1-3, which is the group member, to vehicles 1-4.

Accordingly, the accident vehicle 1-4 may receive information regarding the route change of the target vehicle to be notified 1-3 from the server apparatus 2 and may display the received information on the output device 42 (830).

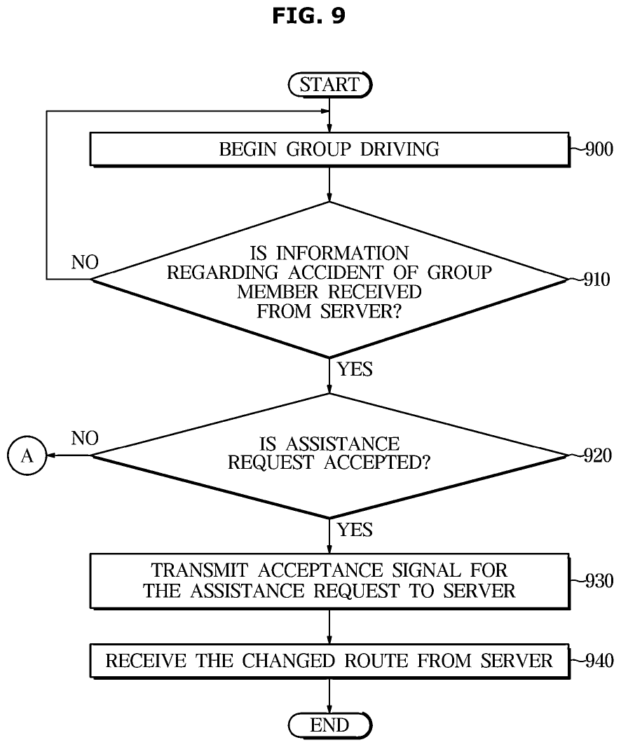

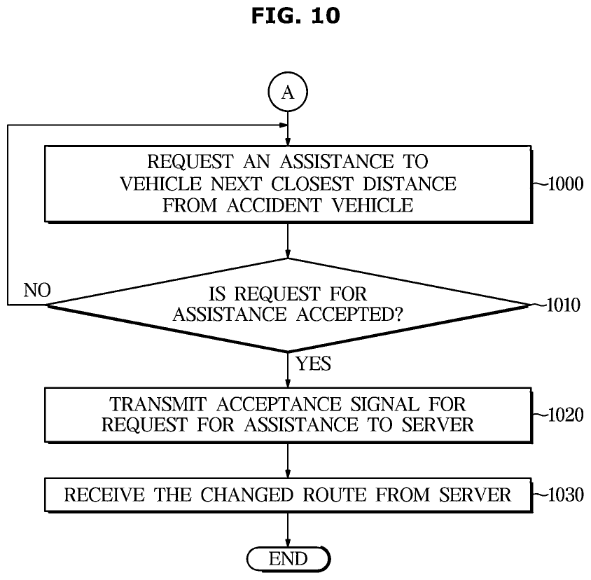

FIG. 9 is a control flowchart of group vehicles excluding the accident vehicle in a server apparatus according to an embodiment. FIG. 10 is a control flowchart, following FIG. 9, of group vehicles excluding the accident vehicle in a server apparatus according to an embodiment.

Referring to FIG. 9 from the viewpoint of the target vehicle to be notified 1, the plurality of vehicles 1 belonging to one group may begin the group driving (900).

When an accident occurs in one vehicle 1 among the plurality of vehicles 1 belonging to the group during the group driving, the target vehicle to be notified 1-3 may receive information regarding the accident of the group member vehicle 1-n from the server apparatus 2 (910).

At this time, the information regarding the accident received by the target vehicle to be notified 1-3 may include a query message about whether to accept the request for assistance. As shown in FIG. 6, the server apparatus may request a vehicle (or a driver of the vehicle) having the closest distance from the accident vehicle 1-4 whether to accept the request for assistance.

Then, when the driver of the target vehicle to be notified 1-3 accepts the request for assistance (Yes in 920), the target vehicle to be notified 1-3 may transmit the acceptance signal for the request for assistance to the server apparatus 2 (930).

The server apparatus 2 may transmit, based on the receiving of the acceptance signal for the request for assistance from the target vehicle to be notified 1-3, the location of the accident vehicle 1-4 to the target vehicle to be notified 1-3 as the destination or may transmit a route to the location of the accident vehicle 1-4 to the target vehicle to be notified 1-3.

Accordingly, the target vehicle to be notified 1-3 may receive the changed destination or the route to the destination from the server apparatus 2 and join the accident vehicle 1-4 (940).

Referring to FIG. 10, when the driver of the target vehicle to be notified 1-3 rejects the request for assistance (No in 920) in FIG. 9, the target vehicle to be notified 1-2, which has the next closest distance from the vehicle 1-3 that rejects the request for assistance from the accident vehicle 1-4, may receive the request for assistance (1000).

Then, as shown in FIG. 9, when the driver of the target vehicle to be notified 1-2 accepts the request for assistance (Yes in 1010), the target vehicle to be notified 1-2 may transmit the acceptance signal for the request for assistance to the server apparatus 2 (1020).

Accordingly, the target vehicle to be notified 1-2 may receive the changed destination or the route to the destination from the server apparatus 2 and join the accident vehicle 1-4 (1030).

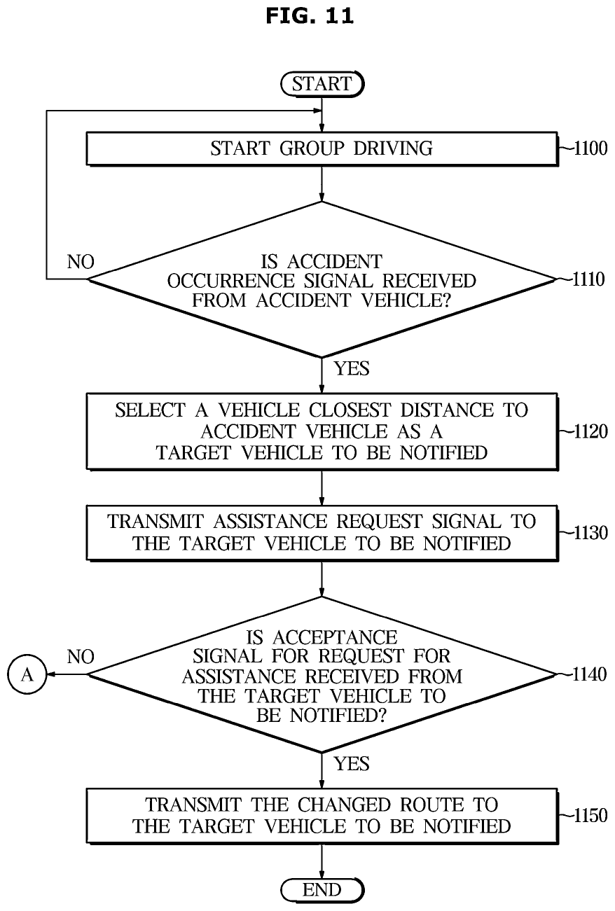

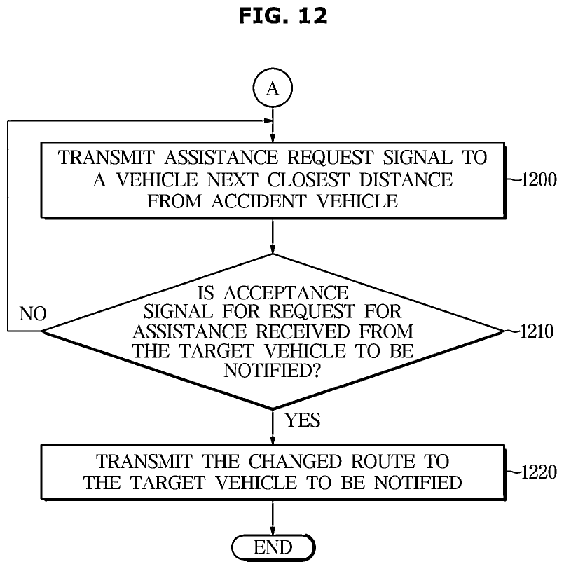

FIG. 11 is a view illustrating a main flow chart of a server apparatus according to an embodiment. FIG. 12, following FIG. 11, is a view illustrating the main flow chart of the server apparatus according to an embodiment.

A method of controlling the server apparatus 2 is described below with reference to FIG. 11 and FIG. 12.

Referring to FIG. 11, the plurality of vehicles 1 belonging to one group may start the group driving (1100).

When an accident occurs in any one of the vehicles 1 belonging to the group while driving in the group, the server apparatus 2 may receive the accident occurrence signal from the accident vehicle 1-4 (Yes in 1110).

Next, the server apparatus 2 may select a vehicle having the closest distance to the accident vehicle 1-4 as the target vehicle to be notified 1-3 (1120).

Based on the selection of the target vehicle to be notified 1-3, the server apparatus 2 may transmit the assistance request signal to the target vehicle to be notified 1-3 (1130).

Then, when the acceptance signal is received as the response signal for the request for assistance from the target vehicle to be notified 1-3 (Yes in 1140), the route in which the location of the accident vehicle 1-4 is changed as the destination may be transmitted to the target vehicle to be notified 1-3 (1150).

As described above, the server apparatus 2 may transmit the location of the accident vehicle 1-4 as the destination to the target vehicle to be notified 1-3 and may change the route on its own in a navigation system of the target vehicle to be notified 1-3.

Referring to FIG. 12 continuously, upon receiving the rejection signal for the assistance request from the target vehicle to be notified in FIG. 11 (No in 1140), the server apparatus 2 may select the target vehicle to be notified 1-2, which has the next closest distance from the accident vehicle 1-4 following the target vehicle to be notified 1-3 as the target vehicle to be notified 1-2. Thereafter, the server apparatus 2 may transmit the assistance request signal to the newly changed target vehicle to be notified 1-2 (1200).

The server apparatus 2 may determine whether the acceptance signal for the request for assistance is received from the changed target vehicle to be notified 1-2 (1210).

As described above, although the server apparatus 2 selects the vehicle, which has the closest distance from the accident vehicle 1-4 following the target vehicle to be notified 1-3, as the target vehicle to be notified 1-2 and transmits the assistance request signal, the target vehicle to be notified 1-2 may reject the request for assistance.

Upon receiving the rejection signal regarding the request for assistance from the target vehicle to be notified 1-2, the server apparatus 2 may select group member 1 (i.e., 1-1) as the target vehicle to be notified 1-1.

As such, the server apparatus 2 may confirm whether the request for assistance is accepted by all vehicles 10 except for the accident vehicle 1-4.

Upon receiving the acceptance signal for assistance request from the changed target vehicle to be notified 1-2 (Yes in 1210), the server apparatus 2 may transmit the changed route to the target vehicle to be notified 1-2 (1220).

As is apparent from the above, the server apparatus and the method of controlling the server apparatus according to various embodiments of the present disclosure may, when an emergency situation occurs while driving in the group, automatically and promptly respond without intervention of the driver and thus contribute to safety of the vehicle and the driver thereof.

Although embodiments of the disclosure have been shown and described, it would be appreciated by those having ordinary skill in the art that changes may be made in these embodiments without departing from the principles and spirit of the disclosure, the scope of which is defined in the claims and their equivalents.

What is claimed is:

1. A server apparatus, comprising:
a communicator configured to communicate with a plurality of vehicles belonging to a predetermined group; and
a controller configured to control, upon receiving an accident occurrence signal from an accident vehicle included in the plurality of vehicles, the communicator to transmit an assistance request signal to a target vehicle to be notified selected based on a location of the accident vehicle of the plurality of vehicles.

2. The server apparatus of claim 1, wherein the controller is further configured to select a vehicle having the closest distance from the accident vehicle among the plurality of vehicles as the target vehicle to be notified.

3. The server apparatus of claim 1, wherein the controller is further configured to control the communicator to receive a response signal regarding a request for assistance from the target vehicle to be notified.

4. The server apparatus of claim 3, wherein the controller is further configured to control the communicator to transmit location information of the accident vehicle to the target vehicle to be notified as a destination based on receiving of an acceptance signal as the response signal for the assistance request from the target vehicle to be notified.

5. The server apparatus of claim 3, wherein the controller is further configured to change, based on receiving of a rejection signal as the response signal for the assistance request from the target vehicle to be notified, a vehicle next closest to the accident vehicle following the target vehicle to be notified received the rejection signal as the target vehicle to be notified.

6. The server apparatus of claim 3, wherein the controller is further configured to control, based on receiving of an acceptance signal as the response signal for the assistance request from the target vehicle to be notified, the communicator to transmit joining information of the target vehicle to be notified to the accident vehicle.

7. The server apparatus of claim 6, wherein the joining information includes at least one of information on a driver of the target vehicle to be notified, a current location, and an expected arrival time to the location of the accident vehicle.

8. The server apparatus of claim 1, wherein the accident occurrence signal includes a collision detection signal or an airbag deployment signal of the accident vehicle.

9. The server apparatus of claim 1, wherein the controller is further configured to control, based on inputting of an instruction regarding the assistance request through an input device by a driver of the accident vehicle, the communicator to transmit the assistance request signal to the target vehicle to be notified.

10. A method of controlling a server apparatus, the method comprising:
receiving an accident occurrence signal from an accident vehicle included in a plurality of vehicles; and
transmitting, upon receiving the accident occurrence signal, an assistance request signal to a vehicle to be notified selected based on a location of the accident vehicle of the plurality of vehicles.

11. The method of claim 10, wherein the selection of the target vehicle to be notified is to select a vehicle having the closest distance from the accident vehicle among the plurality of vehicles as the target vehicle to be notified.

12. The method of claim 10, further comprising receiving a response signal regarding a request for assistance from the target vehicle to be notified.

13. The method of claim 12, further comprising transmitting location information of the accident vehicle to the target vehicle to be notified as a destination based on receiving of an acceptance signal as the response signal for the assistance request from the target vehicle to be notified.

14. The method of claim 12, further comprising changing, based on receiving of a rejection signal as the response signal for the assistance request from the target vehicle to be notified, a vehicle next closest to the accident vehicle following the target vehicle to be notified received the rejection signal as the target vehicle to be notified.

15. The method of claim 12, further comprising transmitting, based on receiving of an acceptance signal as the response signal for the assistance request from the target vehicle to be notified, joining information of the target vehicle to be notified to the accident vehicle.

16. The method of claim 15, wherein the joining information includes at least one of information on a driver of the target vehicle to be notified, a current location, and an expected arrival time to the location of the accident vehicle.

17. The method of claim 10, wherein the accident occurrence signal includes a collision detection signal or an airbag deployment signal of the accident vehicle.

18. The method of claim 10, wherein transmitting the assistance request signal further comprises transmitting the assistance request signal to the target vehicle to be notified based on inputting of an instruction regarding the assistance request through an input device by a driver of the accident vehicle.
